(19) United States
(12) Patent Application Publication
(10) Pub. No.: US 2025/0202026 A1
(43) Pub. Date: Jun. 19, 2025

(54) BATTERY CELL DESIGN WITH A RESEALABLE PRESSURE RELIEF VALVE

(71) Applicant: GM GLOBAL TECHNOLOGY OPERATIONS LLC, Detroit, MI (US)

(72) Inventors: Michelle H. WIEBENGA, Farmington Hills, MI (US); Lei Wang, Rochester Hills, MI (US); Vamakshi Yadav, Sterling Heights, MI (US); Liang Xi, Northville, MI (US)

(21) Appl. No.: 18/541,761

(22) Filed: Dec. 15, 2023

(51) Int. Cl. H01M 50/333; H01M 10/48

(52) U.S. Cl. CPC H01M 50/333; H01M 10/486

(57) ABSTRACT

A battery cell includes a cell housing and an electrode stack disposed within the cell housing. The electrode stack includes a pair of tabs that are in communication with a pair of terminals on the cell housing. A vent is provided in the cell housing and a relief valve is provided in the cell housing, wherein the relief valve has a lower relief pressure than the vent.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a battery cell design with a resealable pressure relief valve.

Early detection of cell venting, such as in the case of thermal events, is useful to the control of lithium-ion batteries for EVs. It has been observed that in the lead-up to a thermal event, gases (H2, etc.) are generated inside the cell before the thermal event can be detected. It has also been observed that gas build up due to cycling over the lifetime of a battery cell can lead to capacity degradation.

### SUMMARY

According to an aspect of the present disclosure, a battery cell includes a cell housing and an electrode stack disposed within the cell housing. The electrode stack includes a pair of tabs that are in communication with a pair of terminals on the cell housing. A vent is provided in the cell housing and a relief valve is provided in the cell housing, wherein the relief valve has a lower relief pressure than the vent.

According to a further aspect, the vent is at a first end of the cell housing and the relief valve is at a second end of the cell housing opposite the first end.

According to a further aspect, the vent and the relief valve are both at one end of the cell housing.

According to a further aspect, the relief valve is integrated into the vent.

According to a further aspect, the relief valve includes a valve member that is biased to a closed position by a spring.

According to a further aspect, the cell housing includes a membrane lining.

According to a further aspect, the relief valve has a release pressure of between 50-300 kPa gauge.

According to a further aspect, the vent has a burst pressure of at least 800 kPa.

The battery cell according to the present disclosure aims to release gas from cells via incorporation of a resealable valve to enable earlier cell heating detection by pack sensors (H2 sensor), and to improve cell performance maintenance by gas removal (>90% CO2). The resealable relief valve could be any one-way valve with a specified cracking pressure (i.e. 50-300 kPa gauge), such as a check valve or pressure relief valve. The valve could incorporate a gas-permeable membrane to prevent electrolyte loss. In prismatic or cylindrical cells the relief valve will open at a lower pressure than the cell vent. In pouch cells, the relief valve will open at a lower pressure than the pressure at which the pouch would burst.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic view of a battery cell with a vent and a pressure relief valve according to the principles of the present disclosure;

FIG. 2 is a schematic view of a battery cell with a vent and a pressure relief valve according to a second embodiment of the present disclosure;

FIG. 3 is a schematic view of a battery cell with a vent and a pressure relief valve according to a third embodiment of the present disclosure;

FIG. 4 is a schematic view of a battery cell with a vent and a pressure relief valve according to a fourth embodiment of the present disclosure;

FIG. 5 is a schematic view of a battery cell with a vent and a pressure relief valve according to a fifth embodiment of the present disclosure; and

FIG. 6 is a schematic view of a battery cell with a vent and a temperature/pressure sensor according to a sixth embodiment of the present disclosure.

In the drawings, reference numbers may be reused to identify similar and/or identical elements.

### DETAILED DESCRIPTION

The present disclosure is directed to a battery cell design which incorporates a resealable valve, such as a check valve or pressure relief valve, to allow gas generated in the cell to escape into the pack enclosure at a specified pressure, lower than a traditional cell vent or pouch burst pressure. This allows the cell to vent gas as it continues to operate. Gas will move in only one direction from the higher pressure inside the cell to the lower pressure outside of the cell preventing moisture from entering the cell. A gas permeable membrane can be incorporated into the valve to prevent electrolyte loss. The gas can then be detected by pack enclosure sensors and corrective action can be taken.

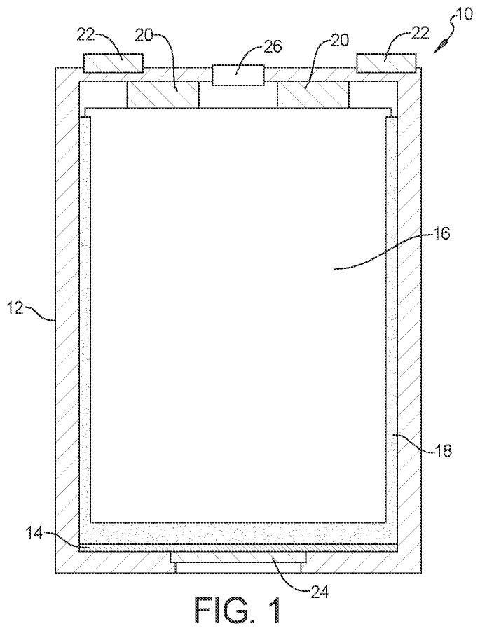

With reference to FIG. 1, a prismatic battery cell 10 according to the principles of the present disclosure will now be disclosed. The prismatic battery cell 10 includes a cell housing 12 that can be lined with a membrane 14. The cell housing can include a can, a pouch, a prismatic box shaped housing or other known cell housing. An electrode stack 16 is disposed within the cell housing and a thermal gap that can be filled with one of an insulating filler, tape or foam 18. The electrode stack 16 includes a pair of tabs 20 that are in communication with a pair of terminals 22. A bottom of the cell housing 12 includes a vent 24. A top of the cell housing 12 includes a relief valve 26. The relief valve 26 has a specified cracking pressure, below a burst pressure of the vent 24, and the relief valve 26 is re-closable after the relief valve 26 is opened. The cracking pressure of the relief valve 26 can be tuned to a pressure (i.e. 50-300 kPa gauge) to optimize thermal release detection and cell performance. As is known in the art, the cell vent 24 is designed to open in response to a thermal runaway event. By way of non-limiting example, the vent 24 can have a burst pressure of 800 kPa. The vent 24 can include a scored, notched or otherwise weakened aluminum sheet that is designed to burst at the designed burst pressure.

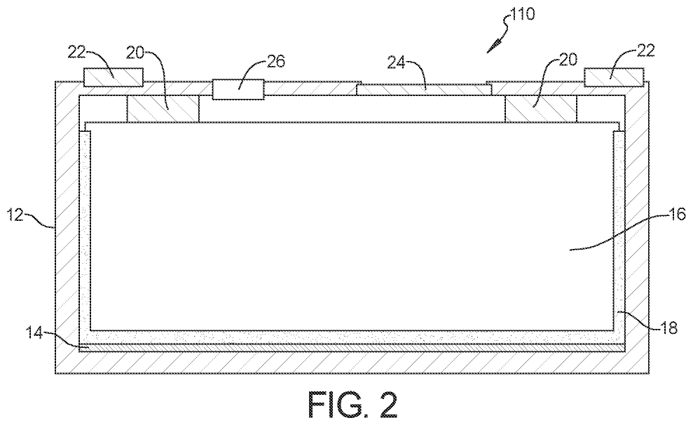

With reference to FIG. 2, a prismatic battery cell 110 according to the principles of the present disclosure will now be disclosed. The prismatic battery cell 110 includes a cell housing 12 that can be lined with a membrane 14. An electrode stack 16 is disposed within the cell can and a thermal gap that can be filled with one of a filler, tape or foam 18. The electrode stack 16 includes a pair of tabs 20 that are in communication with a pair of terminals 22. A top of the cell housing 12 includes a vent 24. A top of the cell housing 12 also includes a relief valve 26. The relief valve 26 has a specified cracking pressure, below a burst pressure of the vent 24, and the relief valve 26 is re-closable after the relief valve 26 is opened. The cracking pressure of the relief valve 26 can be tuned to a pressure (i.e. 50-300 kPa gauge) to optimize thermal release detection and cell performance. As is known in the art, the cell vent 24 is designed to open in response to a thermal runaway event.

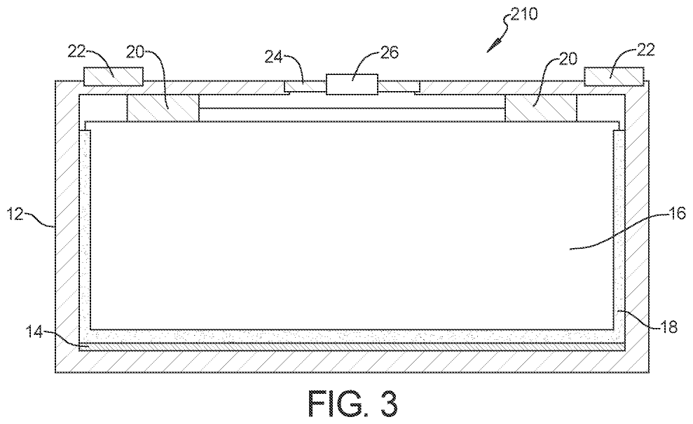

With reference to FIG. 3, a prismatic battery cell 210 according to the principles of the present disclosure will now be disclosed. The prismatic battery cell 210 includes a cell housing 12 that can be lined with a membrane 14. An electrode stack 16 is disposed within the cell can and a thermal gap that can be filled with one of a filler, tape or foam 18. The electrode stack 16 includes a pair of tabs 20 that are in communication with a pair of terminals 22. A top of the cell housing 12 includes a vent 24. A relief valve 26 is integrated with the vent 24. The relief valve 26 has a specified cracking pressure, below a burst pressure of the vent 24, and the relief valve 26 is re-closable after the relief valve 26 is opened. The cracking pressure of the relief valve 26 can be tuned to a pressure (i.e. 50-300 kPa gauge) to optimize thermal release detection and cell performance. As is known in the art, the cell vent 24 is designed to open in response to a thermal runaway event.

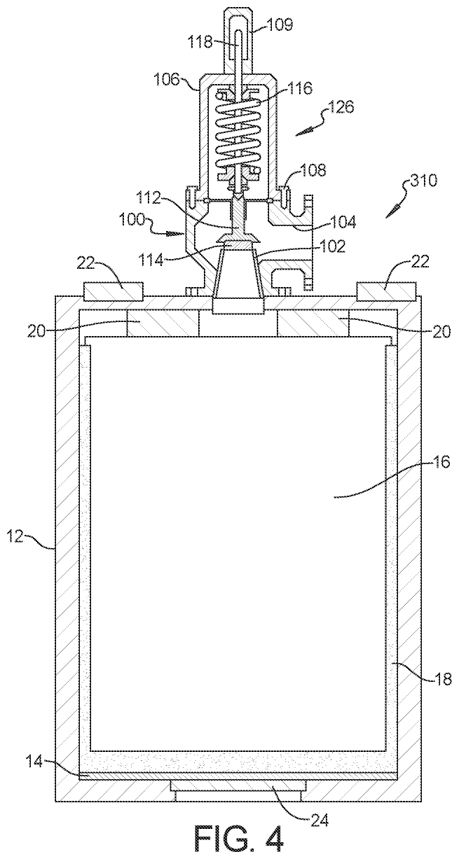

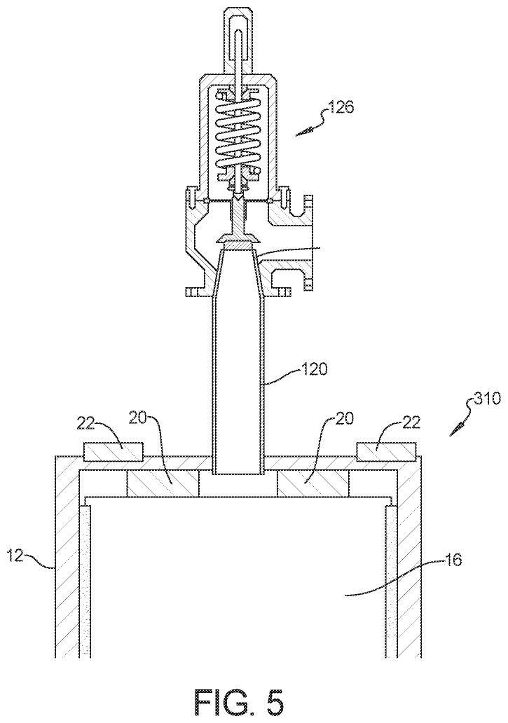

With reference to FIG. 4, a prismatic battery cell 310 according to the principles of the present disclosure will now be disclosed. The prismatic battery cell 310 includes a cell housing 12 that can be lined with a membrane 14. An electrode stack 16 is disposed within the cell housing and a thermal gap that can be filled with one of a filler, tape or foam 18. The electrode stack 16 includes a pair of tabs 20 that are in communication with a pair of terminals 22. A bottom of the cell housing 12 includes a vent 24. A top of the cell housing 12 also includes a relief valve 126. The relief valve 126 has a specified cracking pressure, below a burst pressure of the vent 24, and the relief valve 126 is re-closable after the relief valve 126 is opened. The relief valve 126 can take on alternative forms including, but not limited to, a reed valve, a ball check valve, a piston check valve and a poppet valve. By way of non-limiting example, the relief valve 126 can include a valve body 100 with an inlet nozzle 102 in communication with an outlet passage 128 of the cell can 12 and the valve body 100 includes an exhaust port 104. A bonnet 106 is mounted to the valve body 100 with a seal 108 therebetween. A cap 110 can be mounted to the bonnet 106. A seat holder 112 supports a valve member 114 against the inlet nozzle 102 and is biased into a closed position by a spring 116. A pressure adjusting screw 118 is supported by the bonnet 106 within the cap 109 and can be adjusted to adjust the spring load on the seat holder 112. The cracking pressure of the relief valve 126 can be tuned to a pressure (i.e. 50-300 kPa gauge) to optimize thermal release detection and cell performance. As is known in the art, the cell vent 24 is designed to open in response to a thermal runaway event. With reference to FIG. 5, a tube 120 can connect the relief valve 126 to the outlet passage 128 of the cell housing 12 to provide flexibility in packaging the relief valve 126.

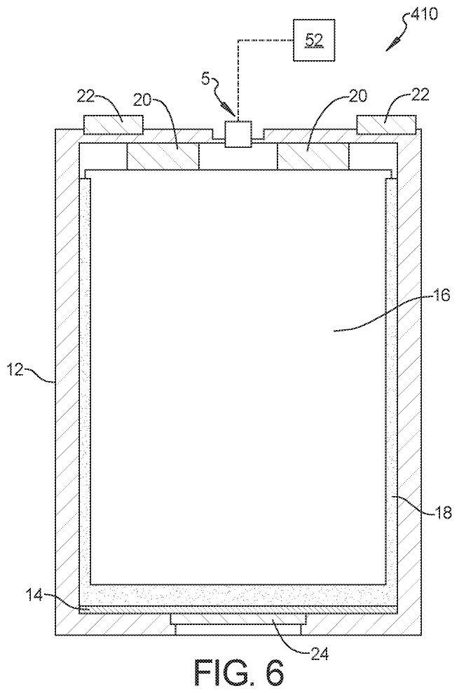

With reference to FIG. 6, a prismatic battery cell 410 according to the principles of the present disclosure will now be disclosed. The prismatic battery cell 410 includes a cell housing 12 that can be lined with a membrane 14. An electrode stack 16 is disposed within the cell can and a thermal gap that can be filled with one of a filler, tape or foam 18. The electrode stack 16 includes a pair of tabs 20 that are in communication with a pair of terminals 22. A bottom of the cell housing 12 includes a vent 24. A top of the cell housing 12 includes at least one of a temperature/pressure sensor 50. The temperature/pressure sensor 50 senses at least one of a temperature and/or pressure of the battery cell. The temperature/pressure sensor 50 can be connected to a battery controller 52 that can be used to deactivate the battery cell 410 in response to a temperature and/or pressure exceeding a predetermined level indicative of a lead-up to a thermal event. As is known in the art, the cell vent 24 is designed to open in response to a thermal runaway event.

This present disclosure provides a novel cell design which incorporates a resealable valve with one-way flow (i.e., check valve or pressure relief valve) and a designated cracking pressure lower than the cell vent pressure in order to allow gas to escape from a cell while the cell continues to operate, preventing performance degradation due to gas build-up in the cell. The pressure relief valve 26 also allows gas generated from cell heating/TR to escape into pack enclosure such that it can be detected earlier than with a traditional vent or pouch bursting. The valve could also be used to release gases generated during formation. The gas permeable membrane can be incorporated into the valve to prevent electrolyte loss. The present disclosure could be applied to any cell format/design/chemistry, with or without existing cell vent for providing earlier venting of gas from cells to prevent degradation due to gas build up in cells, and allow for earlier detection of thermal runaway or cell heating.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell, comprising:
a cell housing;
an electrode stack disposed within the cell housing, the electrode stack including a pair of tabs that are in communication with a pair of terminals on the cell can;
a vent is provided in the cell housing; and
a relief valve is provided in the cell housing, wherein the relief valve has a lower relief pressure than the vent.

2. The battery cell according to claim 1, wherein the vent is at a first end of the cell housing and the relief valve is at a second end of the cell can opposite the first end.

3. The battery cell according to claim 1, wherein the vent and the relief valve are both at one end of the cell housing.

4. The battery cell according to claim 1, wherein the relief valve is integrated into the vent.

5. The battery cell according to claim 1, wherein the relief valve includes a valve member that is biased to a closed position by a spring.

6. The battery cell according to claim 1, further comprising a membrane lining the cell housing.

7. The battery cell according to claim 1, wherein the relief valve has a release pressure of between 50-300 kPa gauge.

8. The battery cell according to claim 1, wherein the vent has a burst pressure of at least 800 kPa.

9. A battery cell, comprising:
a cell housing;
an electrode stack disposed within the cell housing, the electrode stack including a pair of tabs that are in communication with a pair of terminals on the cell housing;
a vent is provided in the cell housing; and
a relief valve is provided in the cell housing and includes a valve member that is biased to a closed position by a spring, wherein the relief valve has a lower relief pressure than the vent.

10. The battery cell according to claim 9, wherein the vent is at a first end of the cell housing and the relief valve is at a second end of the cell housing opposite the first end.

11. The battery cell according to claim 9, wherein the vent and the relief valve are both at one end of the cell housing.

12. The battery cell according to claim 9, wherein the relief valve is integrated into the vent.

13. The battery cell according to claim 9, further comprising a membrane lining the cell housing.

14. The battery cell according to claim 9, wherein the relief valve has a release pressure of between 50-300 kPA gauge.

15. A battery cell, comprising:
a cell housing;
an electrode stack disposed within the cell housing, the electrode stack including a pair of tabs that are in communication with a pair of terminals on the cell housing;
a vent is provided in the cell housing; and
at least one of a temperature and pressure sensor provided in the cell housing and in communication with a battery controller.

16. The battery cell according to claim 15, wherein the vent is at a first end of the cell housing and the at least one of a temperature and pressure sensor is at a second end of the cell housing opposite the first end.

17. The battery cell according to claim 15, further comprising a membrane lining the cell housing.

18. The battery cell according to claim 15, further comprising an insulating material surrounding the electrode stack.

19. The battery cell according to claim 15, wherein the at least one of a temperature and pressure sensor includes a temperature sensor, wherein the battery controller inactivates the battery cell when an interior temperature of the battery cell exceeds a predetermined level.

20. The battery cell according to claim 15, wherein the at least one of a temperature and pressure sensor includes a pressure sensor, wherein the battery controller inactivates the battery cell when an interior pressure of the battery cell exceeds a predetermined level.
